(19) United States
(12) Patent Application Publication
(10) Pub. No.: US 2012/0121311 A1
(43) Pub. Date: May 17, 2012

(54) Magnetically Retained Writing Instrument

(76) Inventor: Ernesto F. Torres, Gilberts, IL (US)

(21) Appl. No.: 12/947,977

(22) Filed: Nov. 17, 2010

(51) Int. Cl. B43K 23/02

(52) U.S. Cl. 401/131

(57) ABSTRACT

A writing instrument having a tubular body with an elongate writing member, such as an ink tube, therein is retained to the palm or the back of a user's hand by a strap around the hand having a magnet therein. A tubular magnetically conductive insert is positioned within the tubular body and around the midsection of the writing member such that the central portion of the writing instrument is attracted to the magnets in the strap thereby retaining the writing instrument to the user's hand.

The present invention relates to a device for retaining a writing instrument near one's hand while the instrument is not in use.

### BACKGROUND OF THE INVENTION

With the computer age, one is required to use fingers to operate keyboards and the like and few individuals make use of pen and pencil except to make occasional notes, checkmarks, or personal entries. With the move toward paperless technology, the use of a pen or pencil has become a secondary method of data entry. Even so, many tasks require frequent use of a pen or pencil for manual entry of notes and it is necessary to maintain a pen or pencil in close proximity to one's work station. Pens and pencils are small, however, and tend to become misplaced. Accordingly, it would be desirable to provide an improved method of retaining a pen or pencil in close proximity to a user's hand such that it will not be misplaced when it is in fact not in use.

### BRIEF DESCRIPTION OF THE INVENTION

Briefly, the present invention is a device for retaining a writing instrument, such as a pen, in close proximity to one's hand. The device includes a strap sized to wrap around a portion of a user's hand. The strap may be in the form of a complete loop or it may be an elongate strap with attachment devices, such as a buckle or loop and hook connectors that allow the ends to be connected and form a loop having a desirable size to fit around the palm of a user's hand, the user's wrist, or elsewhere on the user's arm. The strap includes one or more magnets thereon.

The strap and magnet assembly is used in conjunction with a writing instrument such as a pen or pencil having a generally tubular body. Preferably, the tubular body receives an axially oriented writing element such as an ink tube or pencil lead retainer. The outer circumference of the writing element or ink tube is spaced from the inner wall of the tubular body leaving a cavity therein and inserted in the cavity around the writing element is a tubular magnetically conductive insert. The insert is retained midway along the length of the tubular body. Accordingly, the magnetically conductive insert in the writing instrument will be attracted to the magnet in the strap and the midportion of the writing instrument can be magnetically retained to the portion of the strap containing a magnet.

### BRIEF DESCRIPTION OF THE DRAWINGS

A better understanding of the invention will be had after a reading of the following detailed description taken in conjunction with the drawings wherein:

FIG. 1 is a top elevational view of an elongate strap with connectors at the ends for retaining magnetic elements and attachable to the hand of a user;

FIG. 2 is a side elevational view of a strap configured as a loop with two magnets therein suitable for retaining a writing instrument;

FIG. 3 is cross-sectional view of a pen having a tubular magnetically conductive insert therein;

FIG. 4 is an isometric view of the back side of a user's hand fitted with the strap of the present invention and a pen retained to the strap and against the back of a user's hand;

FIG. 4A is an isometric view of the palm side of a user's hand fitted with the strap of the present invention and a pen retained to the strap;

FIG. 5 is an end view of a flexible band for use with the instrument shown in FIG. 3 in accordance with another embodiment of the invention;

FIG. 6 shows the band of FIG. 5 around the writing instrument of FIG. 3; and

FIG. 7 shows an isometric view of the strap of the present invention having a magnetic flux collector in a flap attached thereto.

### DETAILED DESCRIPTION OF PREFERRED EMBODIMENT

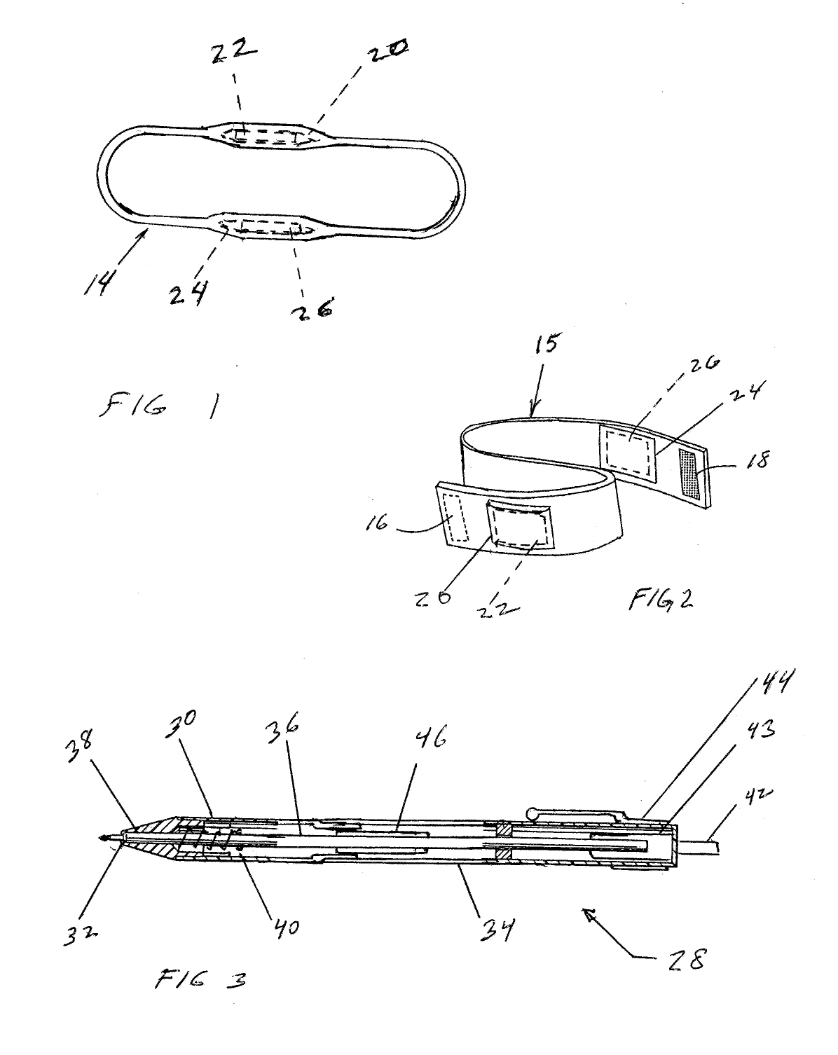

Referring to FIGS. 1 through 4 and 4A, to retain a pen 10 in close proximity to a user's hand 12, a strap is provided that can be wrapped around a portion of the user's hand 12 or arm, not shown. The strap may be made of an elastomeric material and configured as a continuous loop, as is strap 14 depicted in FIG. 1. Alternately, the strap may be made of a fixed length with first and second connectors 16, 18 at the opposite ends thereof as is strap 15 depicted in FIG. 2. The connectors depicted in FIG. 2 are hook and loop type connectors sold under the trademark Velcro® or may be in the form of a belt buckle, a snap, or any other commonly used attachment method.

The strap 14 or 15 (14/15) has a pocket 20 along the length thereof and into the pocket 20 is a permanent magnet 22. It is often desirable that the device have a second pocket 24 spaced from the first pocket 20 with a second permanent magnet 26 in a second pocket 24. When configured as a length, as is strap 15, with the ends 16, 18 joined together, the strap 15 forms a loop and appears similar to strap 14 depicted in FIG. 1, with the loop sized to comfortably fit around the palm of a user's hand 25, or around his wrist or some other portion of the user's arm. When assembled around the user's hand 12, it is desirable that the first and second pockets 20, 24 be spaced from each other such that the first pocket 20 and first magnet 22 are in one side of a user's hand 12 and the second pocket 24 and second magnet 26 are on the opposite side of the user's hand 12. Ideally, the device can then be configured with the first pocket 20 and first magnet 22 adjacent the palm of the user's hand 12 and the second pocket 24 and second magnet 26 adjacent the back of the user's hand 12.

The strap 14/15 with magnets 22, 26 is used in conjunction with a writing instrument, such as a ballpoint pen 28. A ballpoint pen 28 has a tubular body, the forward end of which is configured as a barrel 30, with the inner opening of the barrel having a narrow forward opening 32. At the rearward end of the barrel 30 are female threadings that threaded receive male threadings of a tubular body 34. When the body 34 is threaded to the barrel 30, the parts have a centrally located elongate opening therein that receives an elongate ink tube 36. The ink tub 36 has a narrow diameter forward end 38 that is sized to extend through the narrow opening 32 of the barrel 30. A writing ball at the end of the forward end 38 transfers ink from within the ink tube 36 to a medium such as paper. A coil spring 40 within the barrel 30 urges the ink tube rearwardly within the cavity. A button 42 at the rearward end of the body 34 operates a spring loaded latch 43 that can be latched or unlatched into a depressed condition. In the depressed condition, the ink tube 36 is urged by the latch 43 forwardly within the cavity compressing the spring 40 and forcing the forward end 38 out the narrow opening 32 such that the pen can be used. In the unlatched condition, the spring 40 urges the ink tube 36 rearwardly such that the forward end 38 including the ink ball are withdrawn into the barrel 30 where the parts are protected when not in use. Fitted around the body 34 near the rearward end is a metal clip 44 for clipping the rearward end of the pen 32 over the edge of a pocket or the like of a user.

In accordance with the present invention, a magnetically conductible tubular member 46 is provided that has an inner diameter that is approximately equal to the outer diameter of the ink tube 36 and an outer diameter that is less than the inner diameter of the central opening within the barrel 30 and the body 34 of the pen 28. The tubular member 46 can therefore be tightly fitted around the circumference of the ink tube 36 and the ink tube, with the member 46 compressively attached thereto, can be fitted into the interior of the pen 28. Preferably, the tubular member 46 has an overall length of about one inch and is sized to fit tightly around the circumference of the ink tube 36 such that once assembled thereon it will not be free to slide along the length thereof. In accordance with the invention, the tubular member 46 is fitted around the ink tube 36 at a position that is approximately midway along the length of the pen 28 when the barrel 30 and body 34 are assembled together.

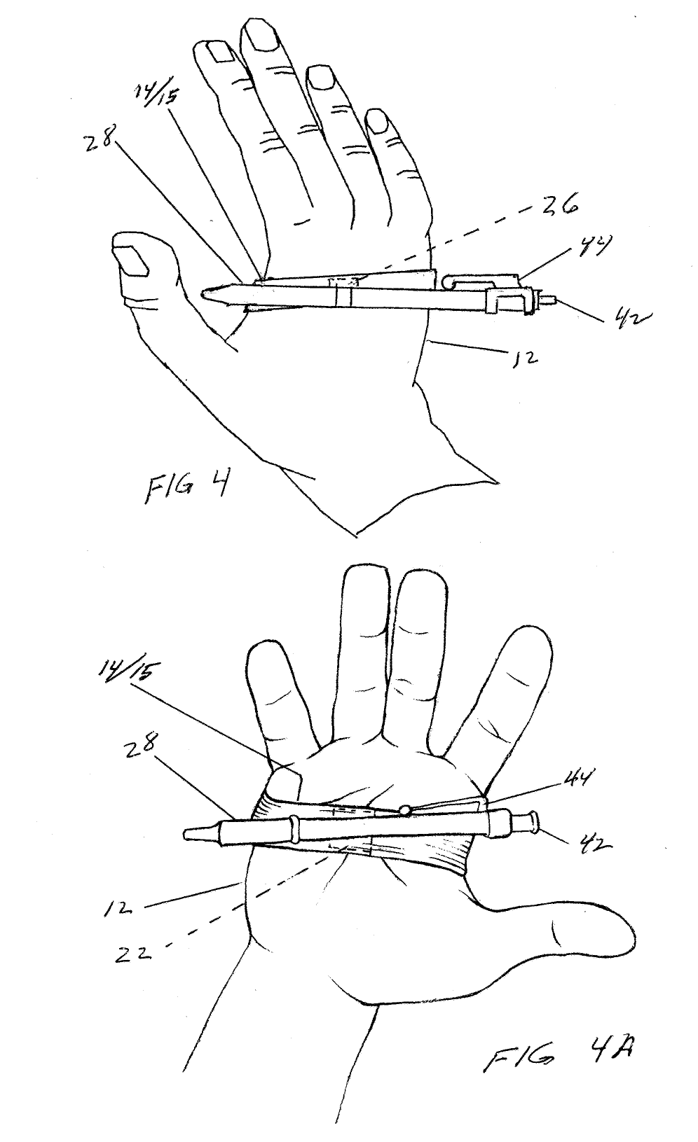

When the tubular member 46 is assembled inside the parts of the pen 28 and the strap 14/15 with the magnets 22, 26 inserted therein is wrapped around the palm of his hand 12 with the first magnet 22 in his palm and the second magnet 26 along the back of his hand, the device is ready for use. The strap 14/15 and magnets 22, 26 are retained against the user's hand and will not interfere with his normal usage of the pen 28 for its intended purpose as a writing instrument. After the user no longer needs the pen 28, the user can move the pen 28 from his fingers and position the central portion of the tubular body of the pen 28 against either his palm or the back of his hand. As shown in FIG. 4A, when the central portion of the pen is positioned across the palm of a user's hand 12, it will be retained against the palm of his hand by the first permanent magnet 22. Alternately, as shown in FIG. 4, the user can choose to position the pen against the back of his hand where the second magnet 26 will retain the pen across the back of his hand.

It should be appreciated that a metal clip 44 at the rearward end of the pen may also made of a magnetically conductive material. Although the clip 44 is magnetically conductive, it is generally not desirable to attach the rearward end of the pen 28 to one of the magnets 22, 26 because movement of the user's hand will cause the forward end of the pen to swing freely and the pen will easily become dislodged from the strap 14/15. The magnetic member 46, however, being positioned generally in the center of the body retains the central portion of the pen 28 to one of the magnets 22, 26 causes a minimum of interference to the user, and the pen will not be dislodged as a result of movement of a user's hand 12.

Although the device 25 has been described as a ballpoint pen, the device could be a mechanical pencil with an internal lead cartridge that is longitudinally moveable within the barrel of the pencil. Except for the substitution of the lead cartridge for the ink tube, the instruments are identical. Accordingly, the invention can be used with a mechanical pencil by inserting a tubular member 46 therein as described above.

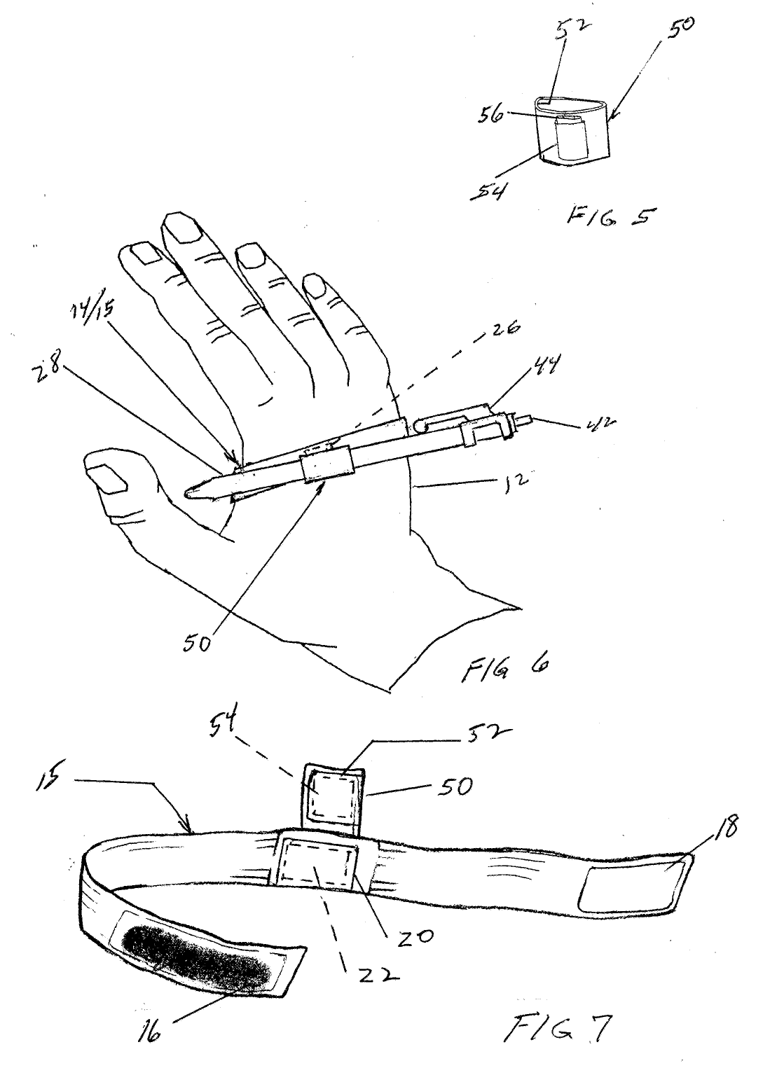

Referring to FIGS. 5 and 6, in another embodiment of the invention, a removable band 50 having an inner opening 52 sized to tightly fit around the circumference of a writing instrument 28 is provided. The band 50 has a pocket 54 therein and fitted into the pocket 54 is a small bar 56 of magnetically conductive material such as iron or steel. The writing instrument 28 can be adapted for use with the strap 14/15 by inserting the writing instrument 28 into the opening 52 of the band 50. Preferably, the band 50 is positioned so that it extends around a central portion of the writing instrument 28. The magnetically conductive bar 56 in the band 50 will therefore be attracted to one of the magnets 22, 26 in the strap 14/15. The band 50 with the magnetically conductive bar 56 will then retain the writing instrument 28 to one of the magnets 22, 26 in the strap 14/15.

Referring to FIG. 7, in another embodiment of the invention, the strap 14/15, in this case depicted as strap 15 which has connectors 16, 18 for retaining the ends in a loop, includes a flexible fabric flap 50 having a pocket 52 therein in which a magnetically conductive member 54 is retained. Preferably, the magnetically conductive member 54 is configured as a plate or disc so as to be flat within the fabric flap 50 and not irritate a user's hand. The flap 50 is positioned adjacent one of the pockets 20 retaining the permanent magnet 22. Ideally, the strap 15 is positioned with the magnet 22 and the flap 50 and magnetically conductive member 54 in the center of the user's palm. The flap 50 and magnetically conductive member 54 can be folded behind the fabric of the strap 15 such that it rests between the strap 15 and the user's hand 12. When in this position, the magnetically conductive member 54 will not reduce the attractive force of the magnet 22 to retain the writing instrument 28. However, if the user does not want to be retaining the writing instrument 28, and he does not want the magnet 22 to attract miscellaneous items on his desk such as paper clips or loose staples, he can pull out the flap 50 from behind the strap 15 and allow the magnetically conductive member 54 to be retained against the outer surface of the pocket 20 containing the permanent magnet 22. When the magnetically conductive member 54 is magnetically retained against the outer surface of the pocket 20, the magnetic flux of the magnet 22 will then be directed through the magnetically conductive member 54 and little or no flux will be available to attract miscellaneous magnetically conductive elements such as staples or paper clips.

While the present invention has been described with respect to a couple embodiments, it will be appreciated that many modifications and variations may be made without departing from the spirit and scope of the invention. It is therefore the intent of the appended claims to cover all such modifications and variations which fall within the spirit and scope of the invention.

What is claimed:

1. A device for retaining a writing instrument comprising
a strap sized to wrap around a portion of a user's body,
a magnet attached to said strap,
a writing instrument having a tubular body and an axially oriented writing insert inside said body,
a magnetically conductive member attachable to said writing instrument, and
said magnetically conductive member positioned at a midpoint along a length of said tubular body.

2. The device of claim 1 wherein
said writing instrument has a cavity between said insert and said body, and
said magnetically conductive member is a tubular member sized to fit around said writing insert and within said body.

3. The device of claim 1 wherein said strap is an elongate member with connectors at the end thereof for connecting said ends to form a loop.

4. The device of claim 1 wherein said strap is configured as a continuous loop.

5. The device of claim 1 wherein said strap has a second magnet attached thereto.

6. The device of claim 1 wherein said writing instrument is a ball point pen.

7. The device of claim 1 wherein said writing instrument is a mechanical pencil.

8. The device of claim 1 and further comprising
a tubular retainer around an outer surface of said writing instrument, and
said magnetically conductive member attached to said tubular retainer.

9. The device of claim 1 and further comprising
a flap attached to said strap adjacent to said magnet, and
a magnetically conductive member retained to said flap.

10. A device for retaining a writing instrument comprising
a strap sized to wrap around a portion of a user's body,
a magnet attached to said strap,
a writing instrument having a tubular body, an axially oriented writing insert, and a cavity between said writing insert and said tubular body,
a magnetically conductive tubular insert around said writing insert and in said cavity, and
said magnetically conductive tubular insert positioned at a midpoint along a length of said tubular body.

11. The device of claim 10 and further comprising
a flap attached to said strap adjacent to said magnet, and
a magnetically conductive member retained to said flap.
